(19) United States
(12) Patent Application Publication
(10) Pub. No.: US 2009/0316211 A1
(43) Pub. Date: Dec. 24, 2009

(54) IMAGE-FORMING DEVICE AND IMAGE-FORMING METHOD

(76) Inventors: Matsuyuki Aoki, Ebina-shi (JP); Satoshi Tanaka, Ebina-shi (JP); Masayuki Aratake, Ebina-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/427,277

(22) Filed: Apr. 21, 2009

(30) Foreign Application Priority Data
Jun. 24, 2008 (JP) 2008-164194

(51) Int. Cl. G06K 15/00; G06K 9/36

(52) U.S. Cl. 358/1.18; 382/284

(57) ABSTRACT

An image-forming device includes: an image-forming unit that forms an image on the basis of first image data; a measuring unit that measures a value of density of a patch image formed by the image-forming unit; a desired value storage unit that stores data on a desired value of density of the patch image; a correction amount calculating unit that calculates a correction amount on the basis of which the measured value is converted into a value identical to or close to the desired value; a condition storage unit that stores data on the measured value, the desired value, the correction amount, and the second image data in the storage unit; and a conversion unit that converts the second image data into third image data, on the basis of the measured value, the desired value, and the correction amount.

### CROSS-REFERENCE TO RELATED APPLICATIONS

This application is based on and claims priority under 35 USC 119 from Japanese Patent Application No. 2008-164194 filed on Jun. 24, 2008.

### BACKGROUND

1. Technical Field

The present invention relates to an image-forming device and an image-forming method.

2. Related Art

When an image-forming device such as a color printer is used for a long time, a value of density of an image formed on a sheet changes. Accordingly, an operation to correct the level of density is performed. The operation is referred to as calibration. Calibration is, specifically, an operation of forming patch images having uniform density on a photoreceptor or an intermediate transfer body, measuring a value of the density of the patch images to compare it with a desired value, and adjusting image-forming conditions on the basis of a result of the comparison.

### SUMMARY

An aspect of the present invention provides an image-forming device including: an image-forming unit that forms an image on the basis of first image data; a measuring unit that measures a value of density of a patch image formed by the image-forming unit; a desired value storage unit that stores a first set of data on a desired value of density of the patch image; a correction amount calculating unit that calculates a correction amount on the basis of the measured value and the desired value, on the basis of which the measured value is converted into a value identical to or close to the desired value; a condition storage unit that stores data on the measured value, the desired value, the correction amount, and the second image data in the storage unit in association with each other; and a conversion unit that converts the second image data into third image data to be output to the image-forming unit, on the basis of the measured value, the desired value, and the correction amount indicated by the first set of data stored in the condition storage unit in association with the second image.

### BRIEF DESCRIPTION OF THE DRAWINGS

Exemplary embodiments of the present invention will be described in detail below with reference to the following figures, wherein:

FIG. 1 is a diagram illustrating a configuration of an image-forming device according to an exemplary embodiment of the present invention;

FIG. 2 is a block diagram illustrating a configuration of a control system of the image-forming device;

FIG. 3 is a flowchart illustrating an operation of a control unit of an image-forming device according to the exemplary embodiment;

FIG. 4 is a diagram illustrating an example of data stored in a storage unit according to the exemplary embodiment;

FIG. 5 is a diagram illustrating an example of an image formed on a sheet according to the exemplary embodiment;

FIG. 6 is a flowchart illustrating an operation of a control unit of an image-forming device according to the exemplary embodiment;

FIG. 7 is a diagram illustrating an example of an image formed on a sheet according to the exemplary embodiment;

FIGS. 8A and 8B are diagrams describing a method of determining a desired value according to a modification;

FIG. 9 is a diagram illustrating an example of data stored in a storage unit according to a modification; and

FIG. 10 is a diagram illustrating an example of a registration screen according to a modification.

### DETAILED DESCRIPTION

An exemplary embodiment of the present invention will be described. In the following description, “repeat printing” means an operation of forming an image having the same color as that of an image that has been formed in the past. Repeat printing is used in a case where an identical image is regularly formed. Repeat printing is realized by a function of forming a subject image using conditions associated with the subject image.

### (1) Configuration

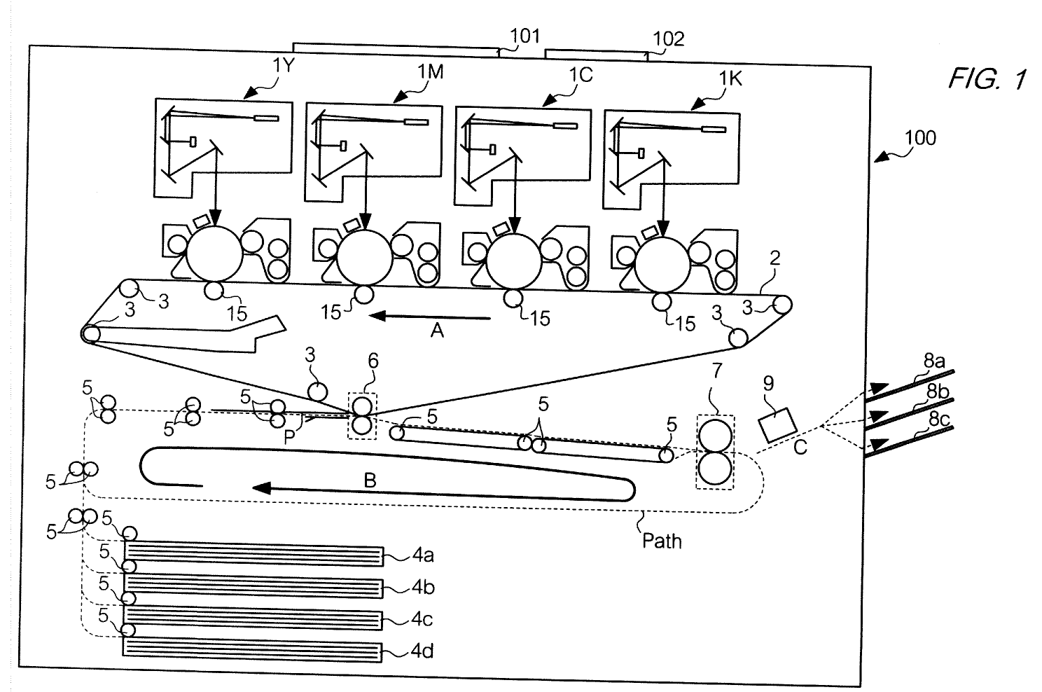

FIG. 1 is a diagram illustrating a configuration of image-forming device 100 according to an exemplary embodiment of the present invention.

Image-forming units 1Y, 1M, 1C, and 1K form an image of yellow (Y), magenta (M), cyan (C), and black (K), respectively. Each of image-forming units 1Y, 1M, 1C, and 1K includes: a photoreceptor which is an image carrier; a charging device that charges the photoreceptor; an exposing device that irradiates light to the photoreceptor on the basis of image data, to form an electrostatic image; a developing device that provides toner to an electrostatic image to form a toner image on a surface of the photoreceptor; first transfer rolls 15 that transfer a toner image to intermediate transfer belt 2; and a cleaner that removes toner remaining on a surface of the photoreceptor after a toner image is transferred to intermediate transfer belt 2.

Intermediate transfer belt 2 is suspended by rolls 3, and is caused by rolls 3 to rotate in the direction of arrow A. Onto intermediate transfer belt 2, toner images formed by image-forming units 1Y, 1M, 1C, and 1K in a layered manner are transferred. Storage trays 4a, 4b, 4c, and 4d store plural sheets of various sizes. A sheet of a specified size is sent from one of storage trays 4a, 4b, 4c, and 4d, and transported along a transport path in the direction of arrow B by transport rolls 5. Second transfer rolls 6 transfer a toner image transferred onto intermediate transfer belt 2 onto a sheet transported along a transport path. Fixing unit 7 fixes a toner image on a sheet by application of heat and pressure. A sheet on which a toner image is fixed is ejected onto one of catch trays 8a, 8b, and 8c as indicated by arrow C. When a sheet is ejected onto one of catch trays 8a, 8b, and 8c, a value of density of an image formed on the sheet is measured by density sensor 9.

On the top surface of image-forming device 100, display unit 100 and operation unit 102 are provided. Display unit 101 has a liquid crystal panel, which drives the panel to display information. The liquid crystal panel functions as a touch panel, whereby a user is able to operate image-forming device 100. A user is also able to operate image-forming device 100 using operation unit 102.

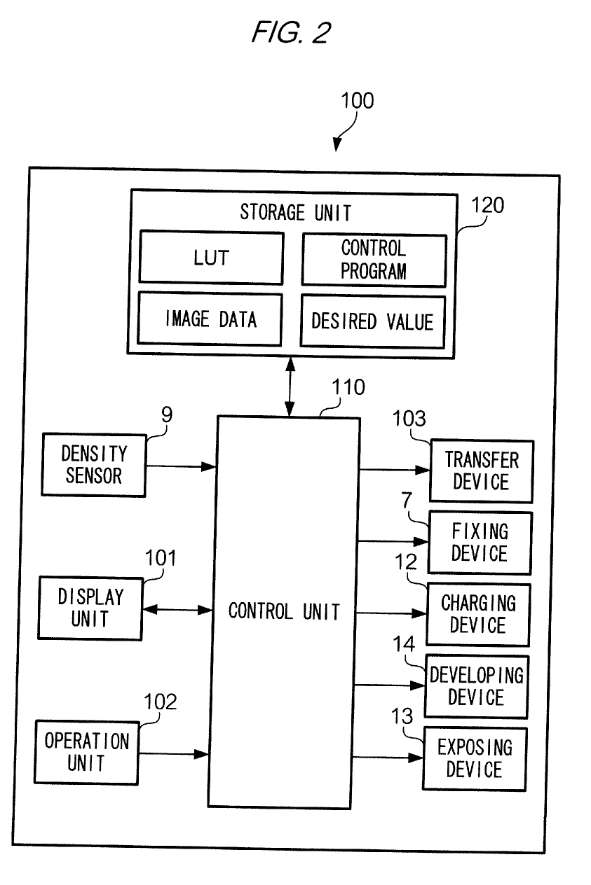

Now, a configuration of a control system of image-forming device 100 will be described with reference to a block diagram shown in FIG. 2.

Control unit 110 is, for example, a CPU (Central Processing Unit), which controls components of image-forming device 100 in accordance with a control program stored in storage unit 120. For example, control unit 110 receives and processes an output signal provided from density sensor 9, or executes an operation instructed by a user, on the basis of an output signal provided from operation unit 102. Also, control unit 110 sends an instruction to display unit 101, transfer device 103, fixing device 7, charging device 12, developing device 14, and exposing device 13 to operate the components. Transfer device 103 includes first transfer rolls 15 that perform a first transfer and second transfer rolls 6 that perform a second transfer.

Storage unit 120 stores control programs, data on image-forming conditions, and plural pieces of image data. Image-forming conditions are conditions on the basis of which an image is formed, and include transfer conditions, fixing conditions, charging conditions, exposure conditions, and conditions on density of toner. However, in the present exemplary embodiment, image-forming conditions refer especially to a desired value and look-up table (hereinafter referred to as “LUT”), which are used when a calibration is performed. A desired value is a value of desired density of patch images. An LUT includes conversion conditions for converting image data stored in storage unit 120 into image data enabling formation of an image having a value identical to or close to a desired value of density. Specifically, an LUT includes an input density value and an output density value stored in association with each other. Image-forming conditions are generated and corrected in accordance with an instruction of control unit 110.

### (2) Operation

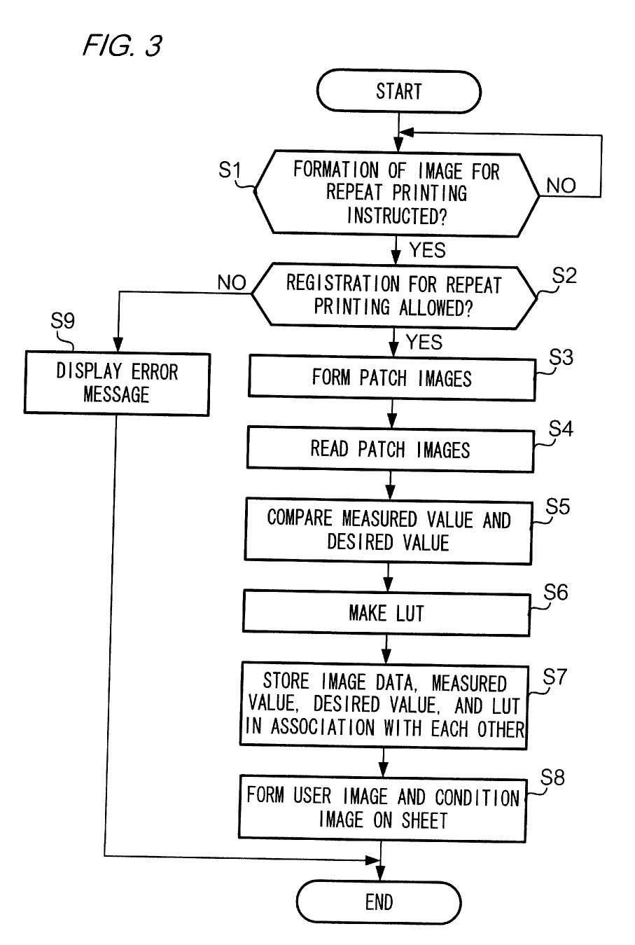

Operations of control unit 110 carried out in accordance with a control program will be described with reference to FIGS. 3 to 7.

In image-forming device 100, two operations are carried out. One is an operation of forming an image for repeat printing, and the other is an operation of forming an image for normal printing. The former is carried out when an identical image with an identical color is regularly formed, as in the case of a printed item such as a business card or a leaflet.

As shown in a flowchart of FIG. 3, if image data is specified by a user, and an instruction to form an image for repeat printing is made (step S1; YES), control unit 110 determines whether it is possible to register an image-forming condition of the image for repeat printing in image-forming device 100 (step S2). It is to be noted that image data to be specified may be image data stored in storage unit 120, or data received from a client such as a personal computer with a server function by a communication device (not shown) via a network. Control unit 100, specifically, determines whether it is possible to register an image-forming condition on the basis of whether image-forming device 100 is in a normal condition. More specifically, control unit 100 may make the determination on the basis of the filled state of toner, or remaining life of a photoreceptor or developer. On the determination being made, if the device is in a normal condition, it is determined that it is possible to register an image-forming condition. On the other hand, if the device is not in a normal condition, it is determined that it is not possible to register an image-forming condition. If the latter determination is made (step S2; NO), control unit 110 causes display unit 101 to display an error message (step S9), and concludes the operation.

If the former determination is made (step S2; YES), control unit 110 causes, prior to image formation of the specified image data, image-forming unit 1 to form plural patch images arranged by grey level on a sheet (step S3). Subsequently, control unit 110 causes density sensor 9 to measure a value of density of the patch images on the sheet, and stores data indicating the measured value in storage unit 120 (step S4). After that, control unit 110 compares the measured value and a desired value stored in storage unit 120 (step S5), and on the basis of the result of the comparison, makes an LUT on the basis of which image-forming unit 1 is able to form an image having the desired value of density (step S6). Control unit 110 stores data on the LUT, the measured value, the desired value, and the specified image data in storage unit 120 in association with each other (step S7).

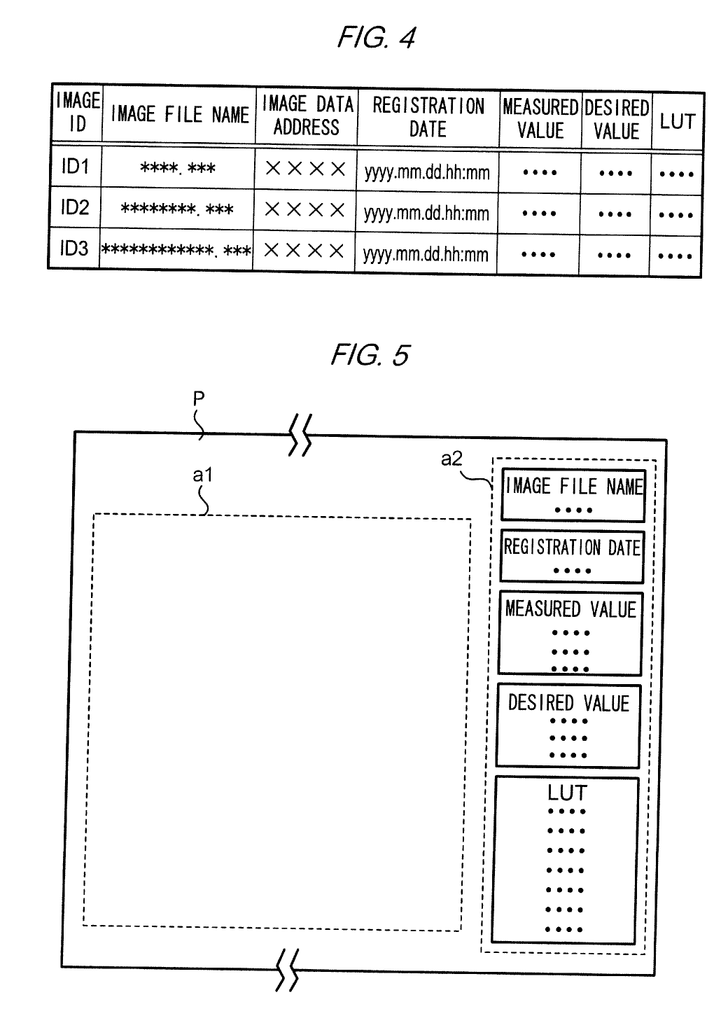

FIG. 4 is a diagram illustrating an example of data stored in storage unit 120 at step S7. For each image, a file name and an image ID which is a unique identifier are assigned, and in storage unit 120, data on a file name, an image ID, an address of image data in storage unit 120, and a registration date are stored in association with data on an LUT, a measured value, and a desired value. Namely, in storage unit 120, image data specified by a user and data on a measured value, a desired, value, and an LUT are stored in association with each other.

Referring to FIG. 3 again, control unit 110 causes image-forming unit 1 to form an image on the basis of the specified image data and content of the LUT. When doing so, control unit 110 causes image-forming unit 1 to form, in addition to the image, an image showing the measured value, the desired value, and the generated LUT on the sheet (step S8).

FIG. 5 is a diagram illustrating an example of an image formed on a sheet at step S8. In area al of sheet P shown in the drawing, an image represented by image data specified by a user (hereinafter referred to as “user image”) is formed. In area a2, an image showing an image file name, a registration date for repeat printing, a measured value, a desired value, and an LUT is formed. The image showing a measured value, a desired value, and content of an LUT is an image showing image-forming conditions registered at step S7 for repeat printing (hereinafter, the image is referred to as “condition image”). Since a condition image is formed in area a2, which is located at an end of sheet P, a user is able to easily remove the image from sheet P to use only a user image.

According to a condition image, a user is able to recognize image-forming conditions of a user image for repeat printing such as a measured value, a desired value, and content of an LUT relating to patch images. Therefore, a condition image is useful in reproducing an image having the same color as an image that has been formed in the past (namely, in performing a repeat printing).

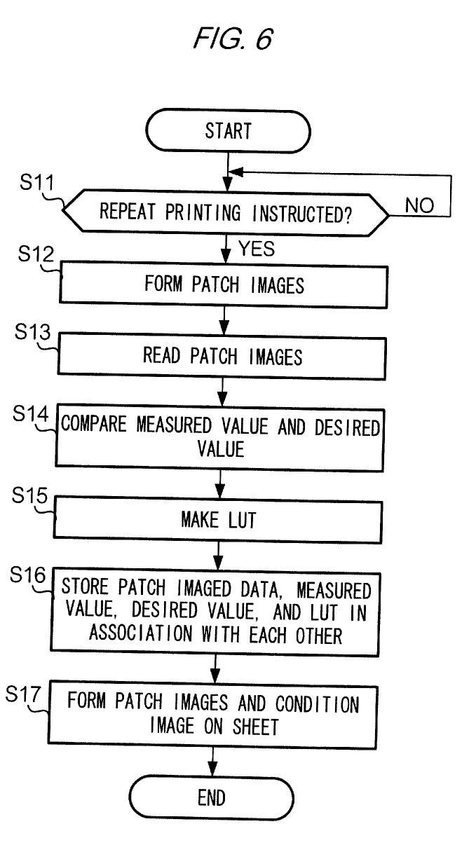

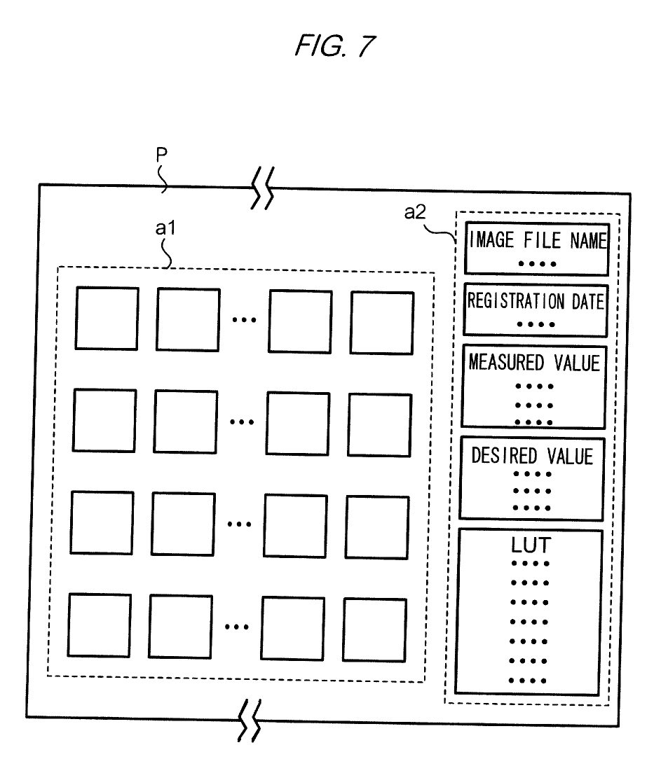

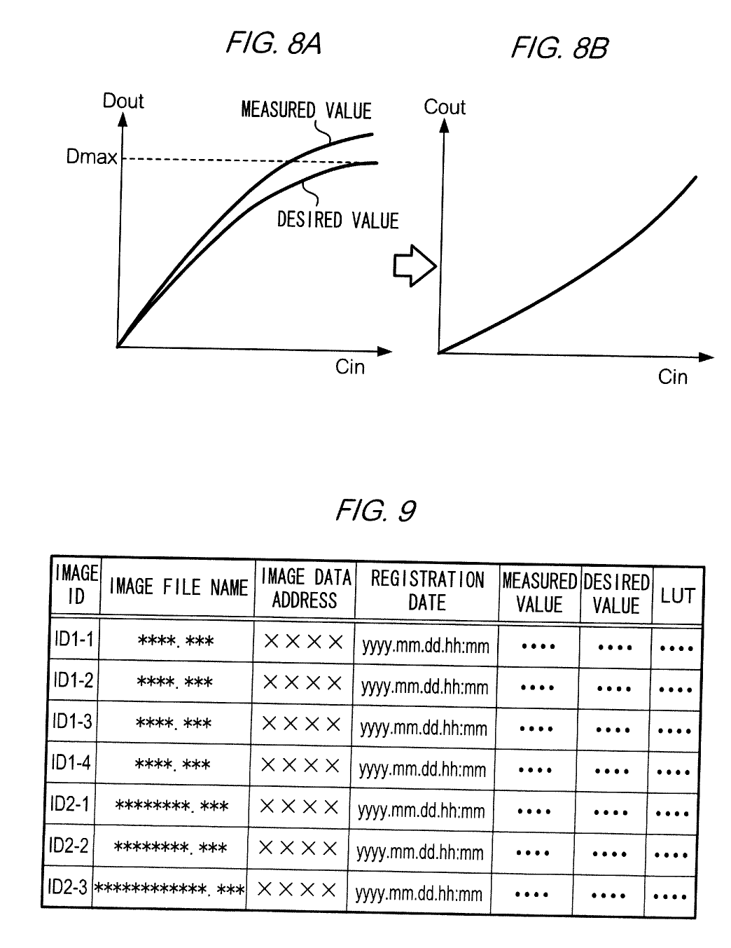

Now, an operation of image-forming device 100 for performing a repeat printing will be described with reference to FIG. 6.

As shown in FIG. 6, if image data is specified by a user, and a repeat printing is requested (step S11; YES), control unit 110 causes image-forming unit 1 to form plural patch images arranged by grey level on a sheet (step S12). When doing so, control unit 110 may use the LUT made at step S6. Subsequently, control unit 110 causes density sensor 9 to measure a value of density of the patch images on the sheet, and stores data on the measured value in storage unit 120 (step S13). Control unit 110 also calculates a difference between the value stored at step S13 and a measured value stored in storage unit 120, that has been registered for repeat printing in association with the specified image data.

Subsequently, control unit 110 compares the value stored at step S13 and a desired value stored in storage unit 120 (step S14). When doing so, control unit 110 considers the difference calculated at step S13. Specifically, control unit 110 adds the difference to a difference between the measured value and the desired value, or multiplies a difference between the measured value and the desired value by a coefficient depending on the difference calculated at step S13.

Subsequently, control unit 110 makes an LUT on the basis of the result of the comparison, on the basis of which image-forming unit 1 is able to form an image having the desired value of density (step S15). After that, control unit 110 stores patch image data representing the patch images and data on the measured value, the desired value, and the LUT in storage unit 120 in association with each other (step S16). Control unit 110 stores the pieces of data as in the case where control unit 110 stores image data specified by a user and data on measured value, a desired value, and an LUT in the operation of FIG. 3.

After that, control unit 110 causes image-forming unit 1 to form patch images on the basis of the batch image data and content of the LUT. When doing so, control unit 110 causes image-forming unit 1 to form, in addition to the patch images, an image showing the measured value, the desired value, and the generated LUT on the sheet (step S17).

FIG. 7 is a diagram illustrating an example of an image formed on a sheet at step S17. In area a3 of the sheet shown in the drawing, patch images represented by patch image data are formed, and in area a4, a condition image showing an image file name, a registration date for repeat printing, a measured value, a desired value, and an LUT is formed. According to a condition image, a user is able to recognize a measured value, a desired value, and content of an LUT registered when a calibration is performed in a repeat printing.

### (3) Modifications

### (3-1) Modification 1

In the above exemplary embodiment, where an LUT enabling formation of an image having a desired value of density pre-stored in storage unit 120 is made, a desired value may be newly determined within the maximal density of a value measured from patch images. FIGS. 8A and 8B are diagrams describing a method of determining a desired value.

As shown in FIG. 8A, control unit 110 may determine a value of density below the lower limit of a scope of the maximal density as a desired value. In this case, in an LUT, a value of output density Cout is lower than that of input density Cin, as shown in FIG. 8B. Namely, a value for decreasing the maximal density of an image represented by image data is used as a conversion condition. According to the present modification, since there is room for adjustment below the maximal density, it is relatively easy to reproduce an image having the same color as that of an image that has been formed in the past.

### (3-2) Modification 2

In the above exemplary embodiment, where for a single piece of image data, a set of a registration date for repeat printing, a measured value, a desired value, and an LUT is registered, for a single piece of image data, plural sets of a registration date for repeat printing, a measured value, a desired value, and an LUT may be registered, as shown in FIG. 9. Namely, variations in image-forming conditions for repeat printing may be created for a single piece of image data. In this case, when an instruction to form an image is made, a set of a registration date for repeat printing, a measured value, a desired value, and an LUT is specified, and control unit 110 coverts image data stored in storage unit 120 into image data to be output to image-forming unit 1, on the basis of the specified set of data.

### (3-3) Modification 3

In the above exemplary embodiment, control unit 110 may cause image-forming unit 1 to form patch images on an image carrier such as a photoreceptor or an intermediate transfer body, instead of a sheet, and carry out a calibration on the basis of the patch images.

Also, image-forming device 100 may be not a tandem image-forming device using intermediate transfer belt 2, but an image-forming device using an intermediate transfer body other than an intermediate transfer belt. Also, image-forming device 100 may employ a system of directly transferring an image onto a recording medium transported by a sheet transport belt or rolls, instead of an intermediate transfer system.

Also, a sheet in the above exemplary embodiment may be another recording medium such as an OHP film.

### (3-4) Modification 4

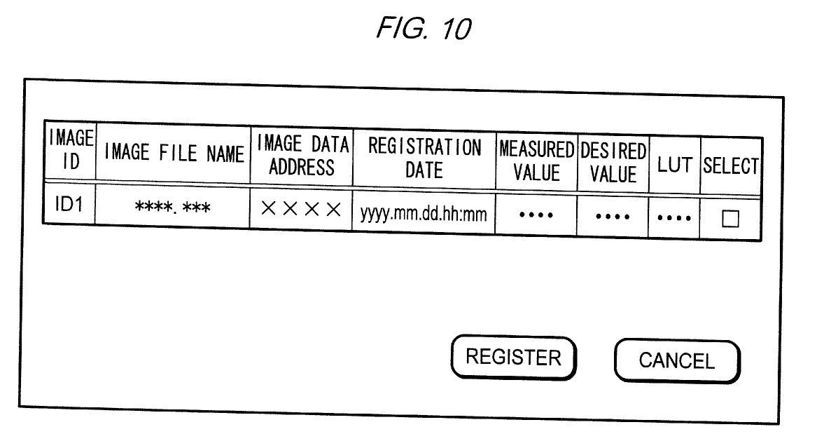

In the above exemplary embodiment, the registration process at step S7 of the operation shown in FIG. 3 may be carried out after an instruction from a user is received. For example, before the registration process is carried out, a registration screen shown in FIG. 10 may be displayed, and in a case where a check box is selected and a registration button is pressed, the registration may be carried out.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image-forming device comprising:
an image-forming unit that forms an image on the basis of first image data;
a measuring unit that measures a value of density of a patch image formed by the image-forming unit;
a desired value storage unit that stores a first set of data on a desired value of density of the patch image;
a correction amount calculating unit that calculates a correction amount on the basis of the measured value and the desired value, on the basis of which the measured value is converted into a value identical to or close to the desired value;
a condition storage unit that stores data on the measured value, the desired value, the correction amount, and the second image data in the storage unit in association with each other; and
a conversion unit that converts the second image data into third image data to be output to the image-forming unit, on the basis of the measured value, the desired value, and the correction amount indicated by the first set of data stored in the condition storage unit in association with the second image.

2. The image-forming device according to claim 1, further comprising an image-forming control unit that causes the image-forming unit to form an image on the basis of the second image data in a recording medium, and to form an image showing the measured value, the desired value, and the correction amount indicated by the first set of data stored in the condition storage unit in association with the second image data, in the recording medium.

3. The image-forming device according to claim 1, further comprising an image-forming control unit that causes the image-forming unit to form the patch image and an image showing the measured value, the desired value, and the correction amount indicated by the first set of data stored in the condition storage unit, in a recording medium.

4. The image-forming device according to claim 1, wherein:
the condition storage unit stores a second set of data on a measured value, a desired value, and an correction amount in accordance with the second image data; and
the conversion unit, if image formation based on the second image data and the first set of data is instructed, converts the second image data into the third image data on the basis of the measured value, the desired value, and the correction amount indicated by the first set of data.

5. The image-forming device according to claim 1, wherein an image represented by the third image data has maximal density lower than an image represented by the second image data.

6. An image-forming method comprising:
forming a patch image on the basis of first image data;
measuring a value of density of the patch image;
providing a storage unit that stores a desired value of density of the patch image;
calculating a correction amount on the basis of the measured value and the desired value, on the basis of which the measured value is converted into a value identical to or close to the desired value;
receiving specification of second image data;
storing a set of data on the measured value, the desired value, the correction amount, and the second image data in the storage unit in association with each other;
converting the second image data into third image data on the basis of the measured value, the desired value, and the correction amount stored in the storage unit in association with the second image; and
forming an image on the basis of the third image data.

7. An image-forming device comprising:
an image-forming means for forming an image on the basis of first image data;
a measuring means for measuring a value of density of a patch image formed by the image-forming means;
a desired value storage means for storing a first set of data on a desired value of density of the patch image;
a correction amount calculating means for calculating a correction amount on the basis of the measured value and the desired value, on the basis of which the measured value is converted into a value identical to or close to the desired value;
a condition storage means for storing data on the measured value, the desired value, the correction amount, and the second image data in the storage means in association with each other; and
a conversion means for converting the second image data into third image data to be output to the image-forming unit, on the basis of the measured value, the desired value, and the correction amount indicated by the first set of data stored in the condition storage means in association with the second image.
